(19) United States
(12) Patent Application Publication
(10) Pub. No.: US 2023/0251064 A1
(43) Pub. Date: Aug. 10, 2023

(54) APPLICATION OF TAILORED FIBER PLACEMENT (TFP) PROCESSES FOR FABRICATION OF NEAR NET SHAPE COMPOSITE BALLISTIC PANELS FOR VEHICLES AND OTHER BALLISTIC PROTECTIVE APPLICATIONS

(71) Applicants: Ford Global Technologies, LLC, Dearborn, MI (US); J. & P. Coats Limited, Glasgow (GB)

(72) Inventors: Alper Kiziltas, Sarikamis (TR); Deborah Frances Mielewski, Ann Arbor, MI (US); Randy Michael Freiburger, Novi, MI (US); John Ilkka, Royal Oak, MI (US); Chung-Lie Ting, Kitchener (CA)

(73) Assignees: Ford Global Technologies, LLC, Dearborn, MI (US); J. & P. Coats Limited, Glasgow, MI (GB)

(21) Appl. No.: 17/870,503

(22) Filed: Jul. 21, 2022

Related U.S. Application Data
(60) Provisional application No. 63/229,673, filed on Aug. 5, 2021.

(51) Int. Cl. F41H 5/04; B32B 5/06; B32B 5/26; B32B 5/12

(52) U.S. Cl. CPC F41H 5/0485; B32B 5/073; B32B 5/26; B32B 5/12; B32B 2571/02; B32B 2605/00; B32B 2260/023; B32B 2260/046; B32B 2262/0269; B32B 2250/20; B32B 2307/7376

(57) ABSTRACT

A net-shape ballistic panel is formed by a process of arranging a fiber bundle on a substrate to form a layer, the layer following a shape of the ballistic panel, securing the fiber bundle to the substrate with a plurality of stitches to form a preform layer, arranging additional layers of fiber bundles on the preform layer, each layer of the additional layers following the shape of the ballistic panel, and each fiber bundle being secured with a plurality of stitches to each layer of the additional layers to form a plurality of preform layers. A resin is then impregnated into the preform layers and subsequently cured using a process such as compression molding. The resulting ballistic panel is relatively thin while exhibiting an excellent ballistic rating (e.g., V50).

### CROSS-REFERENCE TO RELATED APPLICATIONS

This application claims the benefit of and priority to U.S. Provisional Application No. 63/229,673 filed on Aug. 5, 2021. The disclosure of the above application is incorporated herein by reference.

### FIELD

The present disclosure relates to ballistic materials and more specifically to methods of manufacturing ballistic panels for applications in motor vehicles.

### BACKGROUND

The statements in this section merely provide background information related to the present disclosure and may not constitute prior art.

Ballistic panels are employed in a variety of applications, including in high-security motor vehicle applications to protect occupants from external projectiles/threats. One known ballistic panel construction includes two different materials/layers, a backing plate and a ceramic plate. While panels made by this combination of materials can effectively stop projectiles, they require relatively high thicknesses and weight to meet performance specifications.

These relatively high thicknesses preclude use of the ballistic panels with certain vehicle classes where the space within door panels is limited. For example, some police vehicles may not be able to use such ballistic panels because of thickness and contouring necessities, i.e. there is no room inside vehicle doors either due to limited space or the contour.

Ballistic armor, both soft and hard, is fabricated using fabric broad goods that are originally produced via standard weaving processes. The broad good fabrics can be produced using ballistic fibers including aramid, S-glass, and UHMWPE (ultra-high molecular weight polyethylene), among others. Significant waste is generated in cutting and trimming the broad goods to fabricate ballistic preforms and panels. In vehicle armor systems, package space and contour constraints limit the thicknesses and shapes of composite ballistic panels and, thereby, the achievable the U.S. National Institute of Justice (NIJ) level of protection. Additionally, in human protective armor systems, fabrication of ballistic armor components to fit the contour of different body types and genders is either difficult or impossible.

These issues related to the manufacture of ballistic panels are addressed by the present disclosure.

### SUMMARY

This section provides a general summary of the disclosure and is not a comprehensive disclosure of its full scope or all of its features.

A ballistic panel is formed by a process of arranging a fiber bundle on a substrate to form a layer, the layer following a shape of the ballistic panel. The fiber bundle is secured to the substrate with a plurality of stitches to form a preform layer. Additional layers of fiber bundles are arranged on the preform layer, each layer of the additional layers following the shape of the ballistic panel, and each fiber bundle being secured with a plurality of stitches to each layer of the additional layers to form a plurality of preform layers. A resin is then impregnated into the preform layers, and the resin is cured. The ballistic panel is formed in a near net-shape.

In variations of this ballistic panel and process, which may be employed individually or in any combination: the resin is cured in a molding process; the molding process is compression molding; the fiber bundle comprises aramid fibers; threads of the stitches comprise aramid fibers; a thickness of the ballistic panel is less than about 16 mm; and a thickness of the ballistic panel is less than about 8 mm; the plurality of stitches are continuous; and the fiber bundles are in the form of plies.

A motor vehicle having the ballistic panel according to the teachings herein is also contemplated as being with the scope of the present disclosure.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1A is a perspective view of a ballistic panel constructed according to the teachings of the present disclosure;

FIG. 1B is a side view of a layer of the ballistic panel of FIG. 1 having stitching according to the teachings of the present disclosure;

FIG. 2 is an exploded perspective view of the ballistic panel of FIG. 1;

FIG. 3 is a flow diagram illustrated a method according to the teachings of the present disclosure;

FIG. 4A is a photograph of an entry side of ballistic panel manufactured according to the teachings of the present disclosure and subjected to 9 mm projectiles;

FIG. 4B is a photograph of the exit side of the ballistic panel of FIG. 4A; and

FIG. 5 is a graph illustrating the V50 ratings for ballistic panels of varying thickness compared to a ballistic panel manufactured according to the teachings of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Near net-shape ballistic panels and a process for fabricating such panels are provided by the present disclosure. The ballistic panels are formed by a process referred to as a “lattice” process, which is illustrated and described in greater detail in U.S. Published Application No. 2020/0139651 and its related applications, the contents of which are incorporated by reference herein in their entirety. Generally, with the lattice process, fiber bundles are arranged on top of each other and secured together using stitches to form a plurality of preform layers. The preform layers are generated to near net-shape using the unique lattice process and are subsequently impregnated with a resin. The preform layers and resin are subsequently cured, for example by using a compression molding process, thus generating the ballistic panel.

The unique lattice process allows for fabrication of near net shape preforms produced directly from either ballistic fibers (set forth in greater detail below) or commingled thermoplastic fibers/ballistic fibers with no waste generation. Generally, software is used to convert 3D part geometries into 2D preforms and the fiber lay-out can be programmed as specified by the composite laminate design. The lattice process uses an embroidery machine to produce the 2D preforms by stitching ballistic rovings/fibers using aramid thread into a specified near net preform shape and fiber orientation. The final result is a 2D stitched fiber preform that can subsequently be molded into the 3D shape using either thermoplastic or thermoset resins.

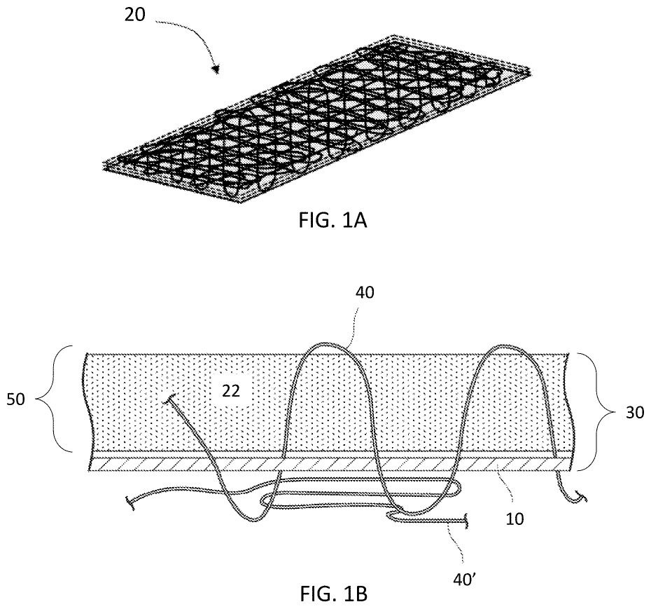

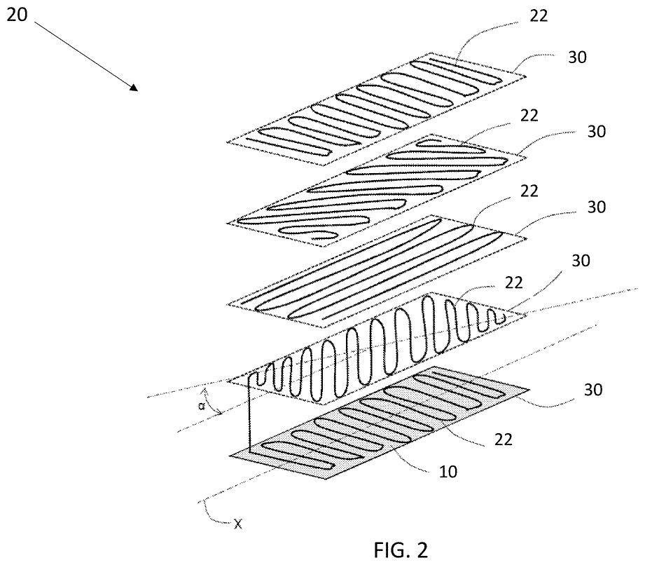

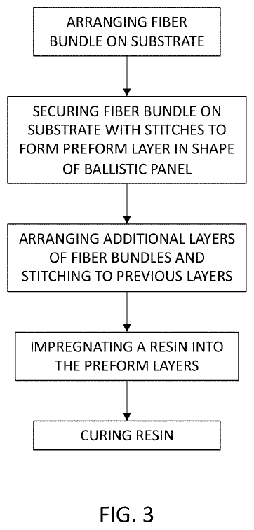

Referring to FIGS. 1A, 1B, 2, and 3, a ballistic panel is illustrated and generally indicated by reference numeral 20. The ballistic panel 20 is formed by arranging a fiber bundle 22 on a substrate 10 to form a layer 30. The layer 30 is illustrated as flat, however, the layer 30 follows a shape of the ballistic panel 20 and is not limited to being flat. For example, the shape may be curved in two or more dimensions, polygonal, and combinations of both. The fiber bundle 22 is secured to the substrate 10 with a plurality of stitches 40 to form a preform layer 50.

The stitches 40 may be continuous through the fiber bundle 22, and additional discrete/separate stitches 40′ may also be employed to secure the fiber bundle 22 to the substrate 10. The stitches 40 may also be attached to the fiber bundle 22 itself (not shown), and the fiber bundles 22 are generally arranged on the substrate 10 according to specific load/strength requirements of a given application.

The fiber bundle 22 may be individual traces as shown, or the fiber bundle 22 may be a continuous layer(s) or ply/plies within a laminate. The fiber bundle 22 may be arranged at any angle α relative to a longitudinal axis X of the ballistic panel 20 according to specific performance requirements of the application.

Additional layers of fiber bundles 22 are then arranged on the preform layer 50, and each layer of the additional layers follows the shape of the ballistic panel 20. Each subsequent fiber bundle 22 is secured with the stitches 40 to each layer 30 of the additional layers to form a plurality of preform layers 50.

After all of the layers are formed, a resin is impregnated into the preform layers 50 and the resin is cured. Example processes include, by way of example, Resin Transfer Molding (RTM), and compression molding, among others. Advantageously, the ballistic panel 20 is formed in a near net-shape.

For the specific ballistic application according to the present disclosure, a ballistic panel for use in a vehicle, the panel thickness is generally less than about 16 mm, and about 8 mm for some applications. These ballistic applications have a requirement of being able to stop a projectile based on NIJ (National Institute of Justice) level 3A, 3, or 4 requirements. The present disclosure thus provides materials and processes that can achieve these NIJ requirements for panels with a thickness less than 16 mm and less than 8 mm.

Test Data

Stitched aramid composite panels formed using the lattice process and having a thickness of 6 mm were tested. The composite panels were formed from multiple preform layers, each preform layer being formed using the lattice process with stitches comprising 3000 Denier aramid fiber/thread. The multiple preform layers were stacked together and compression molded to form the composite panels for testing. The resin for these composite panels was a thermoplastic. A total of ten (10) test shots with a 9 mm projectile were made against the composite panel and the results are shown below in Table 1:

TABLE 1
Sample Test Data

| Sample | | | Threat | | | Range | | | |
|---|---|---|---|---|---|---|---|---|---|
| [symbol] | [symbol] | | [symbol] | [symbol] | | [symbol] | | [symbol] | |
| [symbol] | [symbol] | | [symbol] | [symbol] | | [symbol] | | [symbol] | [symbol] |
| [symbol] | [symbol] | | [symbol] | [symbol] | | [symbol] | | [symbol] | [symbol] |
| [symbol] | [symbol] | [symbol] | [symbol] | [symbol] | [symbol] | [symbol] | | [symbol] | [symbol] |
| [symbol] | [symbol] | | [symbol] | [symbol] | [symbol] | [symbol] | | [symbol] | [symbol] |
| [symbol] | | | [symbol] | [symbol] | | [symbol] | | [symbol] | [symbol] |
| [symbol] | | | | | | | | | |
| [symbol] | | | | | | | | | |
| [symbol] | | | | | | | | | |
| [symbol] | | | | | | | | | |
| [symbol] | [symbol] | [symbol] | [symbol] | [symbol] | [symbol] | [symbol] | [symbol] | [symbol] | [symbol] |
| 1 | [symbol] | [symbol] | [symbol] | [symbol] | [symbol] | [symbol] | N | | X |
| 2 | [symbol] | [symbol] | [symbol] | [symbol] | [symbol] | [symbol] | N | | X |
| 3 | [symbol] | [symbol] | [symbol] | [symbol] | [symbol] | [symbol] | N | | X |
| 4 | [symbol] | [symbol] | [symbol] | [symbol] | [symbol] | [symbol] | Y | | X |
| 5 | [symbol] | [symbol] | [symbol] | [symbol] | [symbol] | [symbol] | Y | | X |
| 6 | [symbol] | [symbol] | [symbol] | [symbol] | [symbol] | [symbol] | Y | X | |
| 7 | [symbol] | [symbol] | [symbol] | [symbol] | [symbol] | [symbol] | Y | X | |
| 8 | [symbol] | [symbol] | [symbol] | [symbol] | [symbol] | [symbol] | N | | X |
| 9 | [symbol] | [symbol] | [symbol] | [symbol] | [symbol] | [symbol] | Y | | X |
| 10 | [symbol] | [symbol] | [symbol] | [symbol] | [symbol] | [symbol] | Y | X | |
| 11 | | | | | | | | | |
| 12 | | | | | | | | | |
| 13 | | | | | | | | | |
| 14 | | | | | | | | | |
| 15 | | | | | | | | | |
| 16 | | | | | | | | | |
| 17 | | | | | | | | | |
| 18 | | | | | | | | | |
| 19 | | | | | | | | | |
| 20 | | | | | | | | | |

| | | | | | |
|---|---|---|---|---|---|
| [symbol] | [symbol] | [symbol] | [symbol] | [symbol] | [symbol] |
| | [symbol] | [symbol] | [symbol] | [symbol] | [symbol] |
| [symbol] | [symbol] | [symbol] | [symbol] | [symbol] | [symbol] |
| | [symbol] | [symbol] | [symbol] | [symbol] | [symbol] |

[symbol]

indicates data missing or illegible when filed

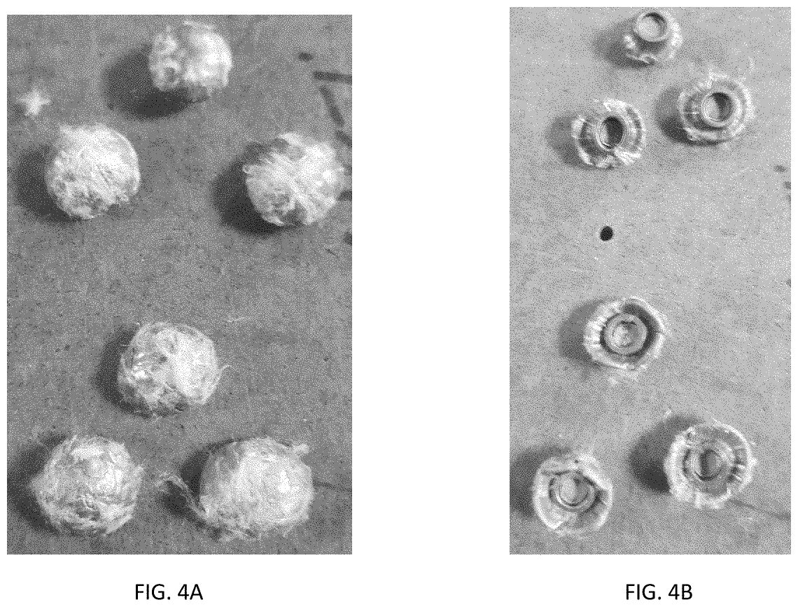

These test results clearly indicate that a 6 mm thick panel is capable of achieving a V50 of 1591.2 fps, with excellent concentricity in deformation of bullets as shown in FIGS. 4A and 4B by using the lattice process.

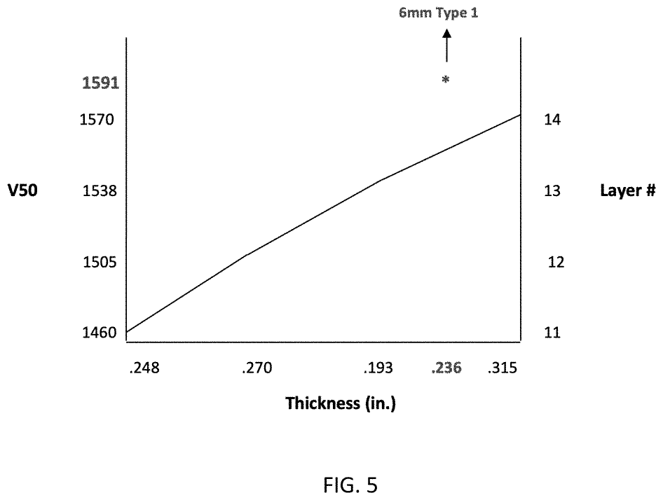

Referring to FIG. 5, a graph of V50 values versus panel thickness and number of layers of 3000 Denier aramid fibers is shown. As shown, the 6 mm thick ballistic panel tested according to the present disclosure has a much higher V50 rating than would be expected for a given number of layers of aramid plain weave fabric without the stitching or lattice process. Therefore, panels manufactured according to the lattice process excellent ballistic capability while allowing a reduced thickness ballistic panel that is able to be used in applications where volume is limited.

In this ballistic application, the fibers of the fiber bundles are an aramid material, such as by way of example Kevlar®, Twaron®, or Heracron®, among others. By way of non-limiting examples, the fiber bundles may alternately comprise carbon, glass, HMWPE (high molecular weight polyethylene), HMPP (high modulus polypropylene), polypropylene, polyester, nylon, PBO (polybenzoxazole), basalt, M5 (polyhydroquinone-diimidazopyridine or PIPD), and natural fibers. Further, these fiber materials may be used in any combination to form a hybrid fiber bundle depending on the specific ballistic application. Further, any number of resin systems may be employed, both thermoplastic and thermoset, for the ballistic panels according to the teachings of the present disclosure.

The yarn, or material used for the stitching may also be any one of a number of materials and in one form is an aramid material. Other materials for the stitches may include, by way of example, carbon or glass. The density of the stitching is specific to the ballistic application and is a function of the Denier of the stitching fibers being used. The stitching pattern and density in different areas of the ballistic panel may also vary according to the teachings of the present disclosure.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A ballistic panel formed by a process of:
arranging a fiber bundle on a substrate to form a layer, the layer following a shape of the ballistic panel;
securing the fiber bundle to the substrate with a plurality of stitches to form a preform layer;
arranging additional layers of fiber bundles on the preform layer, each layer of the additional layers following the shape of the ballistic panel, and each fiber bundle being secured with a plurality of stitches to each layer of the additional layers to form a plurality of preform layers;
impregnated a resin into the preform layers; and
curing the resin,
wherein the ballistic panel is formed in a near net-shape.

2. The ballistic panel according to claim 1, wherein the resin is cured in a molding process.

3. The ballistic panel according to claim 2, wherein the molding process is compression molding.

4. The ballistic panel according to claim 1, wherein the fiber bundle comprises aramid fibers.

5. The ballistic panel according to claim 1, wherein threads of the stitches comprise aramid fibers.

6. The ballistic panel according to claim 1, wherein a thickness of the ballistic panel is less than about 16 mm.

7. The ballistic panel according to claim 6, wherein a thickness of the ballistic panel is less than about 8 mm.

8. A motor vehicle comprising a ballistic panel according to claim 1.

9. The ballistic panel according to claim 1, wherein the plurality of stitches are continuous.

10. The ballistic panel according to claim 1, wherein the fiber bundles are in the form of plies.
